(19) United States
(12) Patent Application Publication
(10) Pub. No.: US 2025/0123373 A1
(43) Pub. Date: Apr. 17, 2025

(54) REFLECTION RATE CORRECTION TOF RANGING

(71) Applicants: PolarisIC Microelectronics Co., Ltd.(Wuhan), Wuhan (CN); PolarisIC Microelectronics Co., Ltd.(Shenzhen), Shenzhen (CN)

(72) Inventors: Xi ZHANG, Wuhan (CN); Linyin SONG, Wuhan (CN); Rui ZHANG, Wuhan (CN); Lin WANG, Wuhan (CN)

(73) Assignees: PolarisIC Microelectronics Co., Ltd.(Wuhan), Wuhan (CN); PolarisIC Microelectronics Co., Ltd.(Shenzhen), Shenzhen (CN)

(21) Appl. No.: 18/991,506

(22) Filed: Dec. 21, 2024

Related U.S. Application Data
(63) Continuation-in-part of application No. PCT/CN2024/097367, filed on Jun. 4, 2024.

(30) Foreign Application Priority Data
Jul. 12, 2023 (CN) 202310857314.2
Dec. 21, 2023 (CN) 202311784536.2
Jun. 4, 2024 (WO) PCT/CN2024/097367

(51) Int. Cl. G01S 7/4865; G01S 7/4861; G01S 7/487; G01S 17/14

(52) U.S. Cl. CPC G01S 7/4865; G01S 7/4861; G01S 7/4873; G01S 17/14

(57) ABSTRACT

A reflection rate correction Time of Flight (ToF) ranging method including: obtaining statistical results of photon flight time of a light pulse reflected by a target object; where the statistical results include detection times of photons and photon quantities corresponding to the detection times; determining a start time of detecting the light pulse based on the statistical results; determining a distance to the target object based on the start time of detecting the light pulse and a start time of emitting the light pulse.

### CROSS-REFERENCE TO RELATED APPLICATION

The present application is a continuation-in-part of International Patent Application No. PCT/CN2024/097367, filed on Jun. 4, 2024, which claims priority to and the benefit of Chinese Patent Application No. 202310857314.2, filed on Jul. 12, 2023. The present application claims priority to and the benefit of the International Patent Application No. PCT/CN2024/097367, the Chinese Patent Application No. 202310857314.2, and Chinese Patent Application No. 2023117845362, filed on Dec. 21, 2023. The contents of the aforementioned patent applications are incorporated herein by reference in their entireties.

### TECHNICAL FIELD

The present disclosure relates to, but is not limited to, the field of ranging, particularly to a reflection rate correction ToF ranging method, apparatus, device, and storage medium and computer program product.

### BACKGROUND

Typically, the Time of Flight (ToF) ranging method involves emitting light pulses from a light pulse emitter (such as a laser emitter). The light pulses strike the target object and are diffusely reflected by the target object to a photon detector. By using a timer to record the start time of the light pulse emission from the light pulse emitter and the end time when the photon detector detects the photons reflected by the target object, the photon flight time is determined. Then, based on the relationship between the speed of light, time, and distance, the distance to the target object is calculated. In practical applications of related technologies, multiple light pulses are generally emitted to generate a large number of photon flight events, and a histogram is obtained by statistically analyzing the number of events corresponding to photon flight time. The peak position of the histogram is identified as the photon flight time for the distance to the target object, and the position of the target object is determined based on the photon flight time. However, there is an issue with the accuracy of determining the photon flight time of the target object using the peak position of the histogram in related technologies. The root cause is that the peak of the histogram deviates from the peak of the histogram for the theoretical distance, and there are various reasons for this deviation, as detailed in the specification and related figures of the present disclosure. How to improve the accuracy of determining photon flight time, thereby improving the accuracy of ranging results, is an urgent problem to be solved.

### SUMMARY

The present disclosure provides a reflection rate correction ToF ranging method, apparatus, device, and storage medium and computer program product.

The present disclosure provides a reflection rate correction ToF ranging method, which includes:
Obtaining statistical results of photon flight time of a light pulse reflected by a target object; where the statistical results include detection times of photons and photon quantities corresponding to the detection times;
Determining a start time of detecting the light pulse based on the statistical results;
Determining a distance to the target object based on the start time of detecting the light pulse and a start time of emitting the light pulse.

The present disclosure provides a reflection rate correction ToF ranging apparatus, which includes:
A single-photon response module, configured to respond to detected photons; where the photons include photons of a light pulse reflected by a target object;
A time information module, configured to obtain detection times of the photons of the light pulse;
A counting module, configured to count and statistically analyze the detected photons to obtain statistical results; where the statistical results include the detection times of photons and photon quantities corresponding to the detection times;
A data processing module, configured to determine a start time of detecting the light pulse based on the statistical results; and to determine a distance to the target object based on the start time of detecting the light pulse and a start time of emitting the light pulse.

The present disclosure provides a reflection rate correction ToF ranging device, which includes:
A single-photon avalanche diode pixel, configured to respond to detected photons; where the photons include photons of a light pulse reflected by a target object;
A time-to-digital converter, configured to obtain detection times of the photons of the light pulse;
A counter, configured to count and statistically analyze the detected photons to obtain statistical results; where the statistical results include the detection times of photons and photon quantities corresponding to the detection times;
A central processor, configured to determine a start time of detecting the light pulse based on the statistical results; and to determine a distance to the target object based on the start time of detecting the light pulse and a start time of emitting the light pulse.

The present disclosure provides a storage medium storing a computer program, which, when executed by a processor, implements at least some or all steps of the method in any embodiment of the present disclosure.

The present disclosure provides a computer program product, which includes a non-transitory computer-readable storage medium storing a computer program, and the computer program, when read and executed by a computer, implements at least some or all steps of the method in any embodiment of the present disclosure.

The technical solution provided by the embodiments of the present disclosure can include the following beneficial effects:

The start time of detecting the light pulse in the present disclosure is not affected by the intensity of the reflected light pulse. The start time of detecting the light pulse is only related to the distance to the target object. Therefore, according to the present disclosure, determining the distance to the target object based on the start time of detecting the light pulse as determined from the statistical results and the start time of emitting the light pulse can reduce the impact on the ranging results caused by different reflectivities of the target object and excessive intensity of the reflected light pulses when the target object is nearby, thereby improving the accuracy of determining the distance to the target object.

It should be understood that the general description and the detailed description in the following text are exemplary and explanatory only and do not limit the present disclosure.

### BRIEF DESCRIPTION OF THE DRAWINGS

The figures included herein are part of the specification and are included to show embodiments in accordance with the present disclosure, and are used in conjunction with the specification to illustrate the present disclosure.

FIG. 1 is a ranging principle diagram of direct photon flight time method;

FIG. 2 is a schematic diagram of SPAD response to photons reflected back from target objects with different reflectivities;

FIG. 3 is a comparative example diagram of photon flight time statistical histograms for ranging target objects with a same distance but different reflectivities by emitting a same light pulse;

FIG. 4 is a comparative example diagram of statistical histogram peaks for ranging target objects with a same distance but different reflectivities by emitting a same light pulse;

FIG. 5 is an example diagram of a ranging system provided by the present disclosure;

FIG. 6 is an example diagram of a timer recording the duration from the emission of the light pulse to the detection of the photons provided by the present disclosure;

FIG. 7A is a flowchart of a reflection rate correction ToF ranging method provided by the present disclosure;

FIG. 7B is another flowchart of a reflection rate correction ToF ranging method provided by the present disclosure;

FIG. 8 is another comparative example diagram of photon flight time statistical histograms for ranging target objects with a same distance but different reflectivities by emitting a same light pulse;

FIG. 9 is an example diagram of the full width at half maxima reflecting the degree of aggregation provided by the present disclosure;

FIG. 10 is an example diagram of the standard deviation-related value reflecting the degree of aggregation provided by the present disclosure;

FIG. 11 is an example diagram of the quartile-related value reflecting the degree of aggregation provided by the present disclosure;

FIG. 12 is an example diagram of statistical histograms corresponding to beams of different return light intensities;

FIG. 13 is yet another flowchart of a reflection rate correction ToF ranging method provided by the present disclosure;

FIG. 14 is an example diagram of a reflection rate correction ToF ranging apparatus provided by the present disclosure;

FIG. 15 is an example diagram of a reflection rate correction ToF ranging device provided by the present disclosure.

### DETAILED DESCRIPTION

Hereinafter, detailed descriptions of exemplary embodiments are provided, which are represented in the accompanying drawings. Unless otherwise indicated, the same numbers in different drawings represent the same or similar elements. The embodiments described below do not represent all possible implementations consistent with the present disclosure. Instead, they are examples of devices and methods consistent with some aspects of the present disclosure as detailed in the appended claims.

In the context of the present disclosure, the use of the articles ‘a’ and ‘an’ is not intended to denote that the nouns they modify are singular or unique. Instead, these articles are used to denote ‘one or more’ of the particular feature or element being described. Similarly, the use of the definite article ‘the’ does not necessarily imply that the noun it modifies is a specific, previously mentioned, or unique instance of that noun. Rather, it is often used to refer to any instance or instances of the noun, whether previously mentioned or not.

The photon flight time method includes indirect photon flight time method (indirect Time of Flight, iToF) and direct photon flight time method (direct Time of Flight, dToF). The principle of direct photon flight time method (dToF) is to measure the distance based directly on the time difference between pulse emission and reception. The electronic clock is activated at the moment of laser emission, the beam manipulation unit guides the pulse to the desired direction, the pulse is reflected back from the target object, and a portion thereof is received by the photoelectric detector. The photoelectric detector connected to the front-end electronic device(s) generates an electrical signal, thereby activating the clock. The distance d to the reflecting object is calculated by measuring the flight time Δt, with the formula d=c*Δt/2, where c refers to the speed of light in the medium. In practical applications, due to the randomness of photon arrival time at the photoelectric detector, multiple laser pulses are generally emitted, and a statistical histogram of photon flight times for a large number of laser pulses is used to determine the most frequent photon flight time as the flight time of photons reflected by the target object, thereby obtaining the distance to the target object.

In related technologies, the peak position in the statistical histogram is generally used to determine the photon flight time for reflection by the target object. However, when the reflectivity of the target object is high, the detection peak may occur prematurely, that is, the detection peak shifts from the ideal peak that reflects the true distance to the target object, leading to measurement errors. This is because the detection elements of the photoelectric detector, such as the Single Photon Avalanche Diode (SPAD), have a dead time after responding to photons. The SPAD is in a “saturated state” during the dead time and cannot detect subsequent photons. A target object with high reflectivity reflects a strong light pulse, causing most of the SPAD pixels in the SPAD array to quickly enter the dead time, and therefore cannot respond to subsequent arriving photons, causing the detection peak to appear prematurely. The following is a detailed explanation in conjunction with the figures.

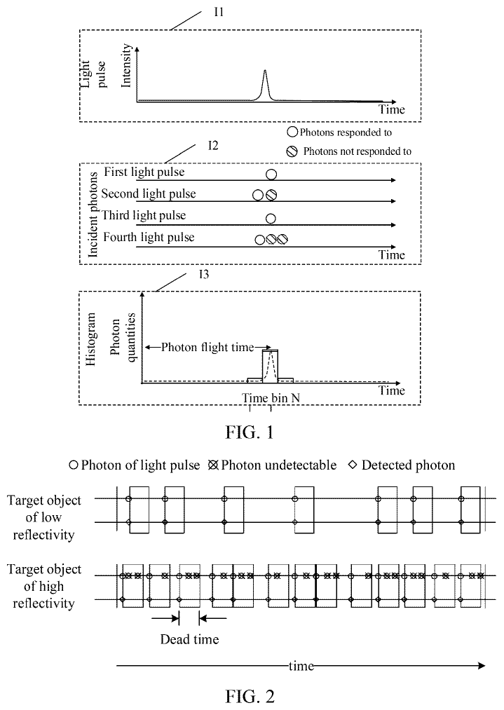

FIG. 1 is a ranging principle diagram of direct photon flight time method. In FIG. 1, I1 identifies the relationship between the emission time and intensity of the light pulse. I2 identifies the relationship between the number of incident photons arriving at the photoelectric detector after reflection of multiple light pulses and the detection time, where each circle represents an incident photon, including photons responded to by SPAD and photons not responded to by SPAD. I3 identifies the pulse signal generated by the SPAD in response to incident photons, and the statistical result obtained by performing a histogram statistics on the time and quantity of the pulse signals, where because the SPAD generates a pulse signal for each responded incident photon, the number of pulse signals is actually the number of incident photons responded to by the SPAD. In the histogram, it includes the distribution of photon quantity in each time bin; the time bin represents a time interval with a certain length of time, and the photon quantity corresponding to the time bin is the total number of photons detected at each detection time falling within that time interval. For example, in the histogram identified by I3, the photon quantity corresponding to the time bin N is the total number of incident photons responded to by the SPAD after the first light pulse is emitted, the second light pulse is emitted, the third light pulse is emitted, and the fourth light pulse is emitted in I2.

In related technologies, based on the histogram statistical results as shown in I3 above, the time corresponding to the peak of the photon quantity is determined as the photon flight time, and the distance to the target object is obtained based on the following formula (1).

$$S = v * ( t / 2 ) ; \qquad ( 1 )$$

where ‘v’ represents the speed of light, and ‘t’ represents the photon flight time.

FIG. 2 is a schematic diagram of SPAD response to photons reflected back from target objects with different reflectivities. In FIG. 2, under the condition that the light pulse has the same intensity when emitted, for a target object with low reflectivity, the reflected light pulse has a low intensity and fewer photons, and the time interval between photons arriving at the SPAD is greater than the dead time of the SPAD, allowing the SPAD to detect all photons. However, for a target object with high reflectivity, the reflected light pulse has a high intensity and a larger number of photons with a higher density, and the time interval between photons is less than the dead time of the SPAD, causing the SPAD to be in the dead time (rectangular boxes) after sensing a photon and unable to sense subsequent photons. As shown in I2 of FIG. 1, due to the existence of the dead time of the SPAD, the SPAD can only sense the first arriving incident photon of each light pulse, and the subsequent arriving incident photons of that light pulse will not be sensed, and thus cannot generate pulse counting/photon counting.

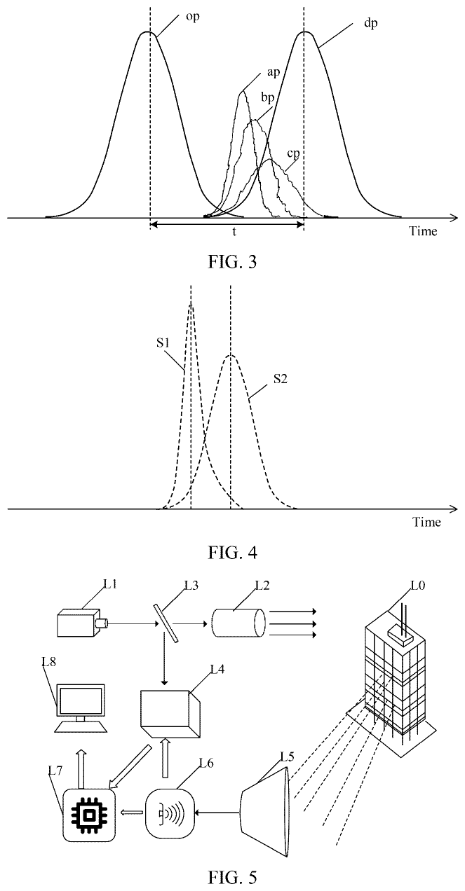

FIG. 3 is a comparative example diagram of photon flight time statistical histograms for ranging target objects with a same distance but different reflectivities by emitting a same light pulse. In FIG. 3, ‘op’ identifies the waveform of the intensity of the emitted light pulse over time, dp identifies the waveform of the intensity of the detected light pulse reflected by the target object under ideal conditions (e.g., no signal attenuations, no optical noise, no response losses, etc.), and it is understood that the abscissa of the highest point of ‘op’ corresponds to the time at which the light pulse is emitted, and the abscissa of the highest point of dp corresponds to the time at which the light pulse is received under ideal conditions, and the duration ‘t’ between the light pulse emission time and the light pulse reception time is the photon flight time under ideal conditions. In FIG. 3, ‘ap,’ ‘bp,’ and ‘cp’ represent the contour curves of the statistical results of photon flight time after the light pulse ‘op’ is reflected by different target objects in actual applications. Among them, ‘ap’ represents the histogram statistical result obtained by the photon flight time method for a target object with the first reflectivity, ‘bp’ represents the histogram statistical result obtained by the photon flight time method for a target object with the second reflectivity, and ‘cp’ represents the histogram statistical result obtained by the photon flight time method for a target object with the third reflectivity, where the first reflectivity is greater than the second reflectivity, and the second reflectivity is greater than the third reflectivity. Due to issues such as light attenuation after the light pulse is emitted, the light intensity (positively correlated with the number of photons) reflected in the histogram is lower than the intensity of the emitted light pulse, meaning that the contour peak heights of ‘ap,’ ‘bp,’ and ‘cp’ are lower than the peak height of op.

As can be seen from FIG. 3, when the same emitted light pulse ‘op’ is used to measure the distance to target objects with the same distance but different reflectivities, the corresponding statistical results of photon flight time reflected in the histogram are also different. The surfaces of the target objects with different reflectivities include reflective strips, white surfaces, black surfaces, stainless steel surfaces, glass mirror surfaces, etc. For example, the peak height, peak width, and the time corresponding to the highest point of the peaks in ‘ap,’ ‘bp,’ and ‘cp’ are all different, leading to different calculated distances for the target objects based on the peak position of the histogram in traditional histogram data processing. It can be understood that because the light intensity of the light pulses reflected by nearby target objects and target objects with high reflectivity is high, nearby target objects will also have the same problem as target objects with high reflectivity, that is, the problem of measurement error caused by the shift of the detection peak.

FIG. 4 is a comparative example diagram of statistical histogram peaks for ranging target objects with a same distance but different reflectivities by emitting a same light pulse; where S1 is the statistical histogram obtained after reflection by a target object with higher reflectivity, and S2 is the statistical histogram obtained after reflection by a target object with lower reflectivity.

It can be seen from the above that in the case of a strong reflected light pulse, such as when the reflectivity of the target object is large, and/or when the target object is nearby, the peak in the histogram shifts due to the SPAD quickly entering the dead time, so using the peak position in the histogram (i.e., the vertex of the histogram contour) to determine the distance to the target object is inaccurate. Specifically, two target objects with different reflectivities but the same distance will have different detected distance values; or two target objects with the same reflectivity but different actual distances will have the same detected distance value. Both of these situations will cause measurement errors.

To solve the above problems, the present disclosure proposes the following scheme.

FIG. 5 is an example diagram of a ranging system provided by the present disclosure, where L1 identifies a laser, L2 identifies an optical emission system, and light pulses generated by the laser are emitted through the optical emission system. The light pulses generated by the laser also pass through the lens identified as L3 and trigger the timer identified as L4 to start timing. For example, the timer is a Time to Digital Converter (TDC). The light pulses emitted by the optical emission system, after being reflected by the target object identified as L0, are received by the optical receiving system identified as L5 and detected by the detection system identified as L6 for photons; while the detection system detects photons, it triggers the timer to stop timing, thereby obtaining the duration from the emission of the light pulse to the detection of the photons based on the timer. After determining the duration from the emission of the light pulse to the detection of the photons, the signal processing system identified as L7 processes the statistical data of the number of detected photons and the duration from the emission of the light pulse to the detection of the photons to determine the photon flight time, and subsequently calculates the distance between the optical emission system and the target object using the aforementioned formula (1).

After obtaining the distance between the optical emission system and the target object, the distance result of the target object can be displayed on the display device identified as L8 in FIG. 5.

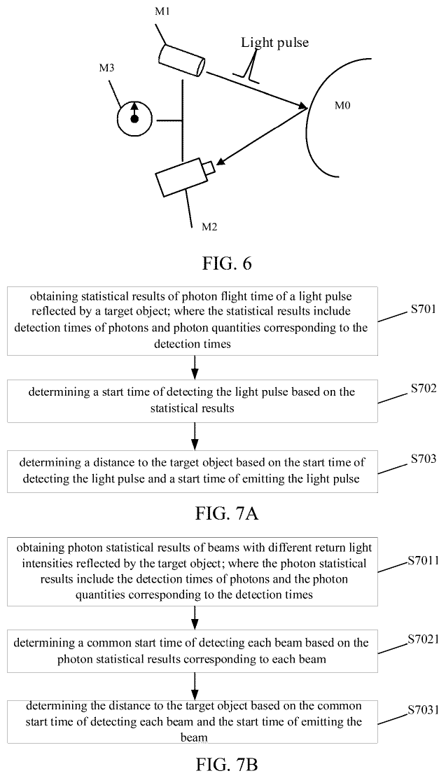

FIG. 6 is an example diagram of a timer recording the duration from the emission of the light pulse to the detection of the photons provided by the present disclosure, where M1 identifies the device emitting the light pulse, corresponding to the aforementioned optical emission system; M0 identifies the target object; M2 identifies the device detecting the light pulse, corresponding to the aforementioned optical receiving system and detection system; M3 identifies the duration from the emission of the light pulse to the detection of the photons recorded by the timer, which is the duration between the emission time of the light pulse and the detection time of the light pulse.

The present disclosure provides a reflection rate correction ToF ranging method, and the executing entity of which can be a photon flight time ranging device (referred to as a ranging device). For example, the photon flight time ranging method can be executed by terminal devices or servers, and can also be executed by a ranging device including the aforementioned light pulse emitter, photon detector, timer, and other devices. In some possible implementations, the photon flight time ranging method can be implemented by a processor calling computer-readable instructions stored in memory. The following description takes the ranging device as the executing entity of the photon flight time ranging method for illustration.

FIG. 7A shows a flowchart of a reflection rate correction ToF ranging method provided by the present disclosure. As can be seen from FIG. 7A, the method includes:
S701, obtaining statistical results of photon flight time of a light pulse reflected by a target object; where the statistical results include detection times of photons and photon quantities corresponding to the detection times;
S702, determining a start time of detecting the light pulse based on the statistical results;
S703, determining a distance to the target object based on the start time of detecting the light pulse and a start time of emitting the light pulse.

As used herein, the term “detection time” refers to the time instance at which a light pulse is detected; therefore, the plural form of “detection times” does not necessarily refer to the number of occurrences the light pulse is detected, but may refer to multiple time instances at which the light pulse is detected.

In the present disclosure, light pulses can be emitted through the aforementioned optical emission system, where the light source can be a Light Emitting Diode (LED), a Laser Diode (LD), an Edge Emitting Laser (EEL), a Vertical-Cavity Surface-Emitting Laser (VCSEL), etc., and the light source emits light pulses under the control of a driver; the light pulse can be a laser, infrared light, ultraviolet light, etc., and the present disclosure does not impose restrictions in this regard.

The present disclosure can detect photons through the aforementioned optical receiving system, where the optical receiving system includes a detection end and optical elements that guide light propagation, such as lenses, microlens arrays, reflectors, or a combination of one or more of these forms, guiding the light signal to the detection end through the optical elements. The detection end can be a single-photon avalanche photodiode (SPAD), or a SPAD array composed of a plurality of SPADs, which can respond to incident single photons and output pulse signals, and a counter correspondingly connected to the SPAD outputs a digital signal, such as output signal “0” indicating no photons detected, and output signal “1” indicating photon detection. In addition, the detection end can also include avalanche photodiodes, photomultiplier tubes, silicon photomultiplier tubes, and other photoelectric conversion devices.

In the present disclosure, after the emission of the light pulse, the photon receiving system, as previously described, responds to the detected photons, and determines the detection time information of the detected photons and the number of photons corresponding to the detection time. Thereby, in step S701, the ranging device obtains the statistical results of the photon flight time of the light pulse reflected by the target object; where the statistical results include the detection times of photons and the photon quantities corresponding to the detection times.

It should be noted that the statistical results of the present disclosure can be represented by the corresponding relationship between the detection times of photons and the number of photons, and can also be represented by a statistical histogram; where the histogram's horizontal coordinate includes a plurality of predetermined time bins, and each time bin represents a time interval, and the photon quantity corresponding to the time bin is the total number of photons detected at each detection time falling within that time interval.

In step S702, the ranging device determines the start time of detecting the light pulse based on the statistical results. For example, the time at which the first photon is detected (the number of photons is greater than zero) in the statistical results can be determined as the start time of detecting the light pulse; or the time at which the number of photons detected earliest is greater than a predetermined quantity threshold in the statistical results can be determined as the start time of detecting the light pulse. In addition, the start time of detecting the light pulse can also be determined based on the shape of the histogram, such as the distribution center of the photon quantities over the detection times, the degree of aggregation of the distribution, etc., and the present disclosure does not impose restrictions in this regard.

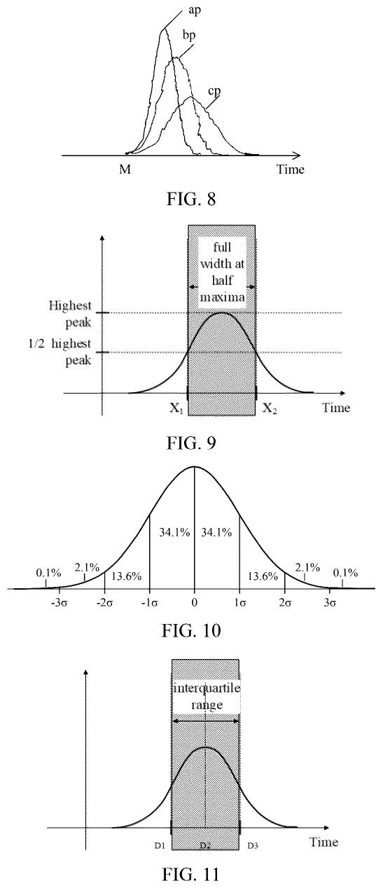

FIG. 8 is another comparative example diagram of photon flight time statistical histograms for ranging target objects with a same distance but different reflectivities by emitting a same light pulse. In conjunction with FIG. 3, it can be understood that the start time of detecting the light pulse can be regarded as the first photon responded by the SPAD in the light pulse, and its arrival time is not affected by the intensity of the reflected light pulse. The arrival time of the first photon is only related to the distance to the target object. Therefore, in the statistical results corresponding to the reflected light pulses ‘ap,’ ‘bp,’ ‘cp’ with different intensities, the starting time points of the contours (i.e., the start times of detecting the light pulse) are the same, i.e., the point M.

Based on the start time of detecting the light pulse adopted in the present disclosure, it will overcome the errors that may be caused by using the time corresponding to the histogram peak value as the photon flight time for reflection by the target object in the existing technology. The reason is that the present disclosure uses the start time of detecting the light pulse to calculate the distance to the target object, it will no longer be affected by the shift of the histogram peak value. In other words, because the present disclosure does not directly use the time corresponding to the histogram peak value as the photon flight time for reflection by the target object, the photon flight time of the present disclosure will not be affected by the peak value shift error, regardless of whether the peak value of the histogram shifts or not.

In step S703, the ranging device obtains the start time of emitting the light pulse; in some embodiments, the start time of emitting the light pulse includes one of a generation time of a control signal, a reception time of the control signal, or an actual emission time of the light pulse; where the control signal is a signal for controlling the emission of the light pulse. For example, the generation time of the control signal can be the time when electronic components such as a CPU, MCU, etc., generate the control signal. The reception time of the control signal can be the time when the optical emission system receives the control signal, or the time when the timer (such as TDC) receives the control signal, where the optical emission system is configured to emit the light pulse based on the received control signal, and the timer is configured to start timing based on the received control signal. In addition, the ranging device can also determine the start time of emitting the light pulse in other ways, such as determining the actual emission time of the light pulse after compensating for the generation time of the control signal with predetermined time compensation parameters, or determining the actual emission time of the light pulse by fitting the time when the optical emission system receives the control signal with a predetermined fitting function, and so on.

After the ranging device in the present disclosure determines the start time of detecting the light pulse and the start time of emitting the light pulse, the position of the target object is determined using the principle of photon flight time ranging.

In some embodiments, the duration between the start time of detecting the light pulse and the start time of emitting the light pulse can be used as the photon flight time, and the distance to the target object can be obtained based on the aforementioned formula (1).

In some embodiments, after obtaining the initial distance based on the duration between the start time of detecting the light pulse and the start time of emitting the light pulse as the photon flight time, the predetermined calibration error can be used for correction, and the corrected result can be used as the distance to the target object; where the predetermined calibration error can be obtained through multiple experiments.

It can be understood that the start time of detecting the light pulse in the present disclosure is not affected by the intensity of the reflected light pulse, and the start time of detecting the light pulse is only related to the distance to the target object. Therefore, according to the present disclosure, determining the distance to the target object based on the start time of detecting the light pulse as determined from the statistical results and the start time of emitting the light pulse can reduce the impact on the ranging results caused by different reflectivities of the target object and excessive intensity of the reflected light pulses when the target object is nearby, thereby improving the accuracy of determining the distance to the target object.

In some embodiments, the determination of the start time of detecting the light pulse based on the statistical results includes:
Determining a distribution center and a degree of aggregation of the photon quantities over the detection times based on the statistical results;
Determining the start time of detecting the light pulse based on the distribution center and the degree of aggregation of the photon quantities over the detection times.

In the present disclosure, determining the distribution center of the photon quantities over the detection times can be achieved in one of the following ways: for example, the detection time corresponding to the maximum photon quantity in the statistical results can be determined as the distribution center, or the detection time corresponding to the highest peak in the histogram can be determined as the distribution center of the photon quantities over the detection times, or a certain time (such as the center time) in the time bin corresponding to the maximum photon quantity in the histogram can be determined as the distribution center of the photon quantities over the detection times. In addition, the centroid algorithm can be used to process the statistical results to determine a centroid of the histogram, and the detection time corresponding to the centroid can be determined as the distribution center of the photon quantities over the detection times.

The ranging device in the present disclosure also determines the degree of aggregation of the photon quantities over the detection times based on the statistical results, where the degree of aggregation indicates the length of the time interval during which a distribution of the photon quantities over the detection times satisfies certain concentration requirements.

In some embodiments, the degree of aggregation of the photon quantities over the detection times can be the length of the time interval between the first detection time when the photon quantity is greater than a quantity threshold and the last detection time when the photon quantity is greater than the quantity threshold.

In some embodiments, the degree of aggregation includes one of: a weighted value of a peak width, a full width at half maxima, a standard deviation-related value, or a quartile-related value in the histogram of the statistical results; where, the standard deviation-related value refers to the length of the time interval corresponding to an integer multiple or a non-integer multiple of the standard deviation in the histogram of the statistical results. For example, it can be the length of the time interval corresponding to one standard deviation, two standard deviations, or three standard deviations in the histogram of the statistical results, or it can refer to the time length corresponding to 0.5 standard deviations, 1.5 standard deviations, 2.5 standard deviations, etc., in the histogram of the statistical results; where the integer multiples of the standard deviation and the non-integer multiples of the standard deviation can be set according to the actual statistical results, and the present disclosure does not impose restrictions in this regard.

The quartile-related value refers to the length of the time interval between any two quartiles in the histogram of the statistical results. For example, the quartile-related value can be the length of the time interval between the first quartile and the third quartile in the histogram of the statistical results, or the length of the time interval between the first quartile and the second quartile, or the length of the time interval between the second quartile and the third quartile, etc. The arbitrary two quartiles can be selected based on the actual statistical results, and the present disclosure does not impose restrictions in this regard.

In some embodiments, the peak width includes bilateral peak width and unilateral peak width, where the bilateral peak width refers to the sum of the peak widths on both sides of the distribution center, and the unilateral peak width refers to the peak width on one side of the distribution center, which can be the left or right side of the distribution center; if the peak width includes bilateral peak width, the corresponding weighted value of the peak width is ½*bilateral peak width; if the peak width includes unilateral peak width, the corresponding weighted value of the peak width is 1*unilateral peak width.

FIG. 9 shows an example diagram of the full width at half maxima reflecting the degree of aggregation provided by the present disclosure, where the positions corresponding to one-half height of the highest peak are time X1 and X2, and the time interval between X1 and X2 is the Full Width at Half Maxima (FWHM). If the waveform of the contour curve in the histogram is relatively symmetrical, the full width at half maxima is approximately equal to half of the bilateral peak width or approximately equal to the unilateral peak width. Under normal distribution, the relationship between the full width at half maxima and the standard deviation σ can be represented by the following formula (2):

$$FWHM \approx 2.355 \times σ \qquad ( 2 )$$

It can be understood that because the weighted value of the peak width, the full width at half maxima, the standard deviation-related value, and the quartile-related value in the histogram of the statistical results can accurately represent the aggregation of the distribution of the photon quantities over the detection times, the present disclosure uses one of the weighted value of the peak width, the full width at half maxima, the standard deviation-related value, and the quartile-related value in the histogram of the statistical results as the degree of aggregation, which can improve the accuracy of representing the aggregation of the distribution of the photon quantities over the detection times, thereby improving the accuracy of determining the start time of detecting the light pulse based on the degree of aggregation and the distribution center.

As shown in FIG. 10, which is an example diagram of the standard deviation-related value reflecting the degree of aggregation provided by the present disclosure, when the contour curve of the statistical results in the histogram is approximately a normal distribution, the degree of aggregation can be reflected by the standard deviation-related value, thereby obtaining the target distance. In FIG. 10, σ represents the standard deviation, and the abscissa “0” at the vertex position of the contour curve corresponds to the distribution center of the statistical results, where the time interval of −1σ˜0 (or 0˜1σ) is the degree of aggregation represented by one standard deviation, the time interval of −2σ˜0 (or 0˜2σ) is the degree of aggregation represented by two standard deviations, and the time interval of −3σ˜0 (or 0˜3σ) is the degree of aggregation represented by three standard deviations. In a normal distribution, 34.1% of all data is within one standard deviation, 47.7% of all data is within two standard deviations, and 49.8% of all data is within three standard deviations.

In some embodiments, the standard deviation can be a distribution standard deviation or a mapping standard deviation; where, the distribution standard deviation refers to the standard deviation that reflects the distribution of the photon quantities over the detection times; specifically, the distribution standard deviation can be obtained by processing the statistical results of the distribution of the photon quantities over the detection times based on the known standard deviation formula, to obtain the standard deviation that reflects the actual statistical results. Therefore, when the contour curve of the statistical results in the histogram presents or is close to a normal distribution, the degree of aggregation can be determined by the standard deviation of the statistical results, and the standard deviation can well reflect the shape of the contour curve in the histogram, thereby having good data reliability when used to determine the degree of aggregation and obtain the distance to the target object based on the degree of aggregation, improving the ranging accuracy.

In some embodiments, the mapping standard deviation refers to the standard deviation determined by the photon quantities based on a predetermined mapping relationship; where, the predetermined mapping relationship is obtained based on multiple photon flight time ranging experiments, and the predetermined mapping relationship includes an “original image” and an “image” corresponding to the “original image”.

In some embodiments, the “original image” can refer to the maximum value of the photon quantity in each unit time interval (such as the time bin of the histogram, etc.) based on multiple experiments; the “image” can refer to the distribution standard deviation of the statistical results in multiple experiments.

In some embodiments, the “original image” can refer to the total photon quantity in all unit time intervals (such as the time bin of the histogram, etc.) based on multiple experiments; the “image” can refer to the distribution standard deviation of the statistical results in multiple experiments.

It should be noted that multiple experiments may obtain multiple mapping relationships, so a relatively stable mapping relationship can be obtained by statistically analyzing the mapping relationships of multiple experiments. The mapping relationship includes a first set composed of a plurality of “original images” and a second set composed of a plurality of “images”, where each “original image” in the first set can be mapped to an “image” in the second set.

It can be understood that because the contour curve in the histogram of the statistical results obtained by detection in actual applications may have noise and other factors (such as ambient light, dark count, system jitter) causing spikes, these spikes will make the calculated distribution standard deviation difficult to accurately reflect the shape of the waveform, and the degree of aggregation represented by the calculated distribution standard deviation will also have a larger error. Therefore, when the contour curve of the ranging statistical results has a larger noise interference, or when it is not a normal distribution or close to a normal distribution in the histogram, the present disclosure can determine the mapping standard deviation based on the predetermined mapping relationship, thereby more accurately representing the degree of aggregation of the photon quantities over the detection times, and obtaining the accurate distance to the target object based on the more accurate degree of aggregation.

In some embodiments, the degree of aggregation can be reflected by the quartile-related value, for example, as shown in FIG. 11, which is an example diagram of the quartile-related value reflecting the degree of aggregation provided by the present disclosure, where D1 is the first quartile, D2 is the second quartile, and D3 is the third quartile, and the width between D3 and D1 is the interquartile range, and the time interval corresponding to the interquartile range is the degree of aggregation.

In some embodiments, determining the start time of detecting the light pulse based on the distribution center and the degree of aggregation of the photon quantities over the detection times includes: subtracting the degree of aggregation from the distribution center of the photon quantities over the detection times to determine the start time of detecting the photons.

In the present disclosure, the start time of detecting the light pulse can be determined by subtracting the degree of aggregation (duration) from the distribution center (time point) of the statistical results, or by moving the distribution center on the time axis in the direction of decreasing time by the width of the degree of aggregation, the corresponding time can be determined as the start time of detecting the light pulse, where the degree of aggregation as described above can be one of the weighted value of the peak width, the full width at half maxima, the standard deviation-related value, and the quartile-related value. By subtracting the degree of aggregation from the distribution center to determine the start time of detecting the light pulse, the unknown parameter for distance measurement can be determined using the existing statistical result parameters, which has the advantage of being simple and easy to implement, and the finally obtained distance to the target object is not affected by factors such as the different reflectivities of the target object and the close distance to the target object, resulting in smaller ranging errors.

It can be understood that in the photon flight time ranging (ToF) method, because the arrival of photons at the SPAD is random in time, if only the time when the first photon is detected is used as the start time of detecting the light pulse, there may be a larger measurement error. Compared with using only the time when the first photon is detected as the start time of detecting the light pulse, the present disclosure determines the start time of detecting the light pulse based on the distribution of the photon quantities over the detection times, using the distribution center and the degree of aggregation, which can eliminate the random error of the first detected photon, improve the accuracy of the start time of detecting the light pulse, and thereby improve the accuracy of determining the distance to the target object.

Furthermore, considering the effects of light attenuation and light noise (manifested as spikes in the histogram), the ranging device can also perform smoothing filtering on the statistical results after obtaining them, and determine the distribution center and the degree of aggregation of the photon quantities over the detection times in the smoothed and filtered statistical results.

In some embodiments, determining the start time of detecting the light pulse based on the distribution center and the degree of aggregation of the photon quantities over the detection times includes:
Obtaining a compensation coefficient related to the degree of aggregation, and using the compensation coefficient to compensate for the degree of aggregation;
Subtracting the compensated degree of aggregation from the distribution center of the photon quantities over the detection times to determine the start time of detecting the light pulse.

In the present disclosure, the ranging device obtains a compensation coefficient related to the degree of aggregation, uses the compensation coefficient to compensate for the degree of aggregation, and subtracts the compensated degree of aggregation from the distribution center of the photon quantities over the detection times to determine the start time of detecting the light pulse. Where, the compensation coefficient related to the degree of aggregation can be obtained based on multiple experiments in the environment required for the application, or can be determined based on the current measurement environment combined with the parameters of the ranging statistical results, and the present disclosure does not impose restrictions in this regard.

For example, if the degree of aggregation is the full width at half maxima, the start time of detecting the light pulse=distribution center−full width at half maxima*compensation coefficient corresponding to the full width at half maxima; if the degree of aggregation is the standard deviation-related value, the start time of detecting the light pulse=distribution center−standard deviation-related value*compensation coefficient corresponding to the standard deviation-related value. Through this scheme, the compensated degree of aggregation can be more matched to the interval between the distribution center and the start time of detecting the light pulse, so that using the distribution center minus the degree of aggregation to determine the start time of detecting the light pulse is more accurate, realizing the error correction of the degree of aggregation, that is, improving the accuracy of determining the start time of detecting the light pulse, and thereby improving the accuracy of determining the distance to the target object.

In some embodiments, determining the distance to the target object based on the start time of detecting the light pulse and the start time of emitting the light pulse includes:
Obtaining a calibration error;
Determining a time difference between the start time of detecting the light pulse and the start time of emitting the light pulse;
Determining the distance to the target object based on the calibration error and the time difference.

In the present disclosure, due to factors such as delays in the transmission of control signals, the start time of emitting the light pulse is difficult to determine. Therefore, the photon flight time determined based on the start time of detecting the light pulse and the start time of emitting the light pulse may have errors because the determined start time of emitting the light pulse is not the actual emission time of the light pulse. This can lead to errors in the measurement of the distance to the target object determined by the photon flight time. In this regard, the present disclosure can obtain a calibration error, and after determining a time difference between the start time of detecting the light pulse and the start time of emitting the light pulse, determine the distance to the target object based on the calibration error and the time difference.

Where, the calibration error can be a time calibration error or a distance calibration error. The calibration error can be determined by the ranging device based on historical experiments, or can be sent by other electronic devices, and the present disclosure does not impose restrictions in this regard. The calibration process of the present disclosure can set target objects at multiple known distances (assuming 10 meters, 15 meters, etc.), the laser emitter emits a laser that is reflected by the target object and detected by the SPAD, and the distances solved in the histogram are 10.05 meters and 15.05 meters, respectively, thus determining the distance calibration error to be 0.05 meters. This calibration error can be regarded as the measurement error caused by signal transmission delays. In subsequent actual measurements, this calibration error is used to compensate for the measurement results, which can obtain accurate ranging results reduced by the measurement error caused by signal transmission delays. Consequently, based on the distance calibration error and the constant of the speed of light, the time calibration error can be determined.

If the calibration error is a time calibration error, the duration between the start time of detecting the light pulse and the start time of emitting the light pulse determined by the aforementioned method can be compensated by the calibration error to determine the corrected photon flight time, and then the distance to the target object can be determined based on the photon flight time method.

If the calibration error is a distance calibration error, the duration between the start time of detecting the light pulse and the start time of emitting the light pulse determined as the photon flight time can be calculated to obtain the distance, and the distance can be compensated by the calibration error to determine the distance to the target object. Through this scheme, the impact of the error in determining the start time of emitting the light pulse on the ranging result can be reduced, thereby improving the accuracy of determining the distance to the target object.

It should be noted that the applicant found in actual applications that when calculating the photon flight time based on the photon statistical results reflected by the target object, if these light pulses belong to a same beam (only one histogram is generated), the histogram may be distorted due to some factors such as fewer histogram events, noise, spikes, etc., which makes the initial time of detecting the light pulse calculated by the aforementioned method have errors, thereby leading to measurement errors. To address this problem, the applicant has made further optimizations on the basis of the aforementioned scheme, and the optimization scheme is as follows:

In some embodiments, obtaining the statistical results of the photon flight time of light pulses reflected by the target object includes: obtaining photon statistical results of beams with different return light intensities reflected by the target object; the determining the start time of detecting the light pulse based on the statistical results includes: determining a common start time of detecting each beam based on the photon statistical results corresponding to each beam; determining the distance to the target object based on the start time of detecting the light pulse and the start time of emitting the light pulse includes: determining the distance to the target object based on the common start time of detecting each beam and the start time of emitting the beam.

FIG. 7B is another flowchart of a reflection rate correction ToF ranging method provided by the present disclosure. In some embodiments, the reflection rate correction ToF ranging method includes:
S7011, obtaining photon statistical results of beams with different return light intensities reflected by the target object; where the photon statistical results include the detection times of photons and the photon quantities corresponding to the detection times;
S7021, determining a common start time of detecting each beam based on the photon statistical results corresponding to each beam;
S7031, determining the distance to the target object based on the common start time of detecting each beam and the start time of emitting the beam.

The present disclosure can detect beams with different return light intensities reflected from the same target object after emitting multiple beams of different intensities; or detect beams with different return light intensities reflected from multiple target objects with the same distance to be measured and different light reflection rates after emitting multiple beams of the same intensity; it can also detect beams with different return light intensities reflected from the same target object after emitting multiple beams of the same intensity, by using photoelectric elements of different sensitivities. It can be understood that the return light intensity of the beams reflected by the target object in the present disclosure is related to the distance to be measured of the target object, the light reflection rate of the target object, the intensity of the beams emitted to the target object, or the sensitivity of the photoelectric elements; among which, the different sensitivities of the photoelectric elements can be achieved by activating a different number of pixels of photoelectric elements (such as SPAD pixel arrays), or by using photoelectric elements with different photoelectric performance (such as different fill factors) due to different structures/materials as detection units.

In some embodiments, in step S7021, the ranging device determines the common start time of detecting each beam based on the photon statistical results corresponding to each beam. Where, the photon statistical results of each beam are the photon statistical results of multiple beams reflected by the same target object, or the photon statistical results of multiple beams reflected by multiple target objects with the same distance to be measured, and the start time of detecting each beam is only related to the distance (distance to be measured) of the target object (to the ranging device), therefore, the start times of detecting each beam (with the emission time of each beam as the time zero point) are theoretically the same, referred to as the “common start time.” In practice, there may be slight differences in the start times of detecting each beam. Therefore, after determining the start times corresponding to each beam, the average, median, or other weighted results of these start times can be taken as the common start time of detecting all beams.

In some embodiments, in step S7031, the ranging device obtains the start time of emitting the beam; where, obtaining the start time of emitting the beam can be the start time of emitting one beam, or the start time of emitting multiple beams; It should be noted that when emitting multiple beams, the time of emitting each beam is used as the timing start point, so that the start times of detecting each beam are the same in the subsequent process, obtaining the common start time of detecting each beam. After the ranging device in the present disclosure determines the common start time of detecting each beam and the start time of emitting the beam, the distance to the target object to be measured is determined using the principle of photon flight time ranging.

In some embodiments, determining the distance to the target object based on the common start time of detecting each beam and the start time of emitting the beam includes:
Determining a time difference between the common start time of detecting each beam and a start time of emitting any one beam;
Using the time difference as the photon flight time, and determining the distance to the target object based on the photon flight time.

In the present disclosure, because the measurement is for the same target object or target objects with the same distance to be measured, theoretically, the time difference (i.e., photon flight time) between the start time of detecting each beam and the start time of emitting each beam is the same, therefore, the start time of emitting any one beam can be regarded as the common start time of emitting each beam, and the photon flight time can be determined based on the start time of emitting any one beam and the common start time of detecting each beam, thereby determining the distance to be measured.

In some embodiments, determining the common start time of detecting each beam based on the photon statistical results corresponding to each beam includes:
Determining, for the photon statistical results corresponding to each beam, a distribution center and a degree of aggregation of the photon quantities over the detection times corresponding to the beam;
Obtaining a first relationship between the start time of detecting the beam and the distribution center, the degree of aggregation, and a scaling factor corresponding to the beam, as well as a second relationship between the start times of detecting each beam;
Determining the common start time of detecting each beam based on the first relationship and the second relationship.

In the present disclosure, after determining the distribution centers and the degrees of aggregation of the photon quantities over the detection times corresponding to each beam, the first relationship including the start time of detecting the beam, the distribution center, the degree of aggregation, and the scaling factor is obtained; where, the scaling factor can include a coefficient acting on the degree of aggregation, so the first relationship can be represented by the following formula (3):

$${t}_{0} = {C}_{1} - {V}_{a 1} * k \qquad ( 3 )$$

where, t₀ represents the start time of detecting the beam, C₁ represents the distribution center, Vₐ₁ represents the degree of aggregation, and k represents the scaling factor.

In addition, the present disclosure also obtains the second relationship, which includes the relationship that the start times of detecting each beam are the same. For example, the start time of detecting the first beam is t₁, the start time of detecting the second beam is t₂, and the start time of detecting the third beam is t₃ . . . , then the second relationship can be represented by the equation: t₁=t₂=t₃ . . . .

It can be understood that on the one hand, the present disclosure can use the existing photon statistical result parameters of multiple beams to determine the unknown parameter of the common start time of detecting each beam, unaffected by factors such as the different reflectivities of the target object and the close distance to the target object, resulting in smaller ranging errors. On the other hand, compared with determining the common start time of detecting each beam based only on the time when the first photon of each beam is detected, the present disclosure determines the common start time of detecting each beam based on the distribution of the photon quantities over the detection times, using the first relationship and the second relationship including the distribution center and the degree of aggregation, which can eliminate the random error of the first detected photon, improve the accuracy of the common start time of detecting each beam, and thereby improve the accuracy of determining the distance to the target object.

In some embodiments, determining the common start time of detecting each beam based on the first relationship and the second relationship includes:
Under a condition that types of degree of aggregation of the photon statistical results corresponding to each beam are the same, determining a target scaling factor based on the first relationship and the second relationship;
Determining the common start time of detecting each beam based on the target scaling factor and the first relationship.

In the present disclosure, when the types of degree of aggregation of the photon statistical results corresponding to each beam are the same, the corresponding scaling factor is also the same. For example, if the degree of aggregation is represented by the standard deviation, based on the aforementioned first relationship and the second relationship, the following formula (4) is obtained:

$${t}_{0} = {C}_{1} - {V}_{a 1} * k = {C}_{2} - {V}_{a 2} * k = … \qquad ( 4 )$$

where, C₁ represents the distribution center corresponding to one beam, Vₐ₁ represents the degree of aggregation corresponding to one beam, C₂ represents the distribution center corresponding to another beam, Vₐ₂ represents the degree of aggregation corresponding to the other beam, k represents the target scaling factor; and t₀ represents the start time of detecting the beam, and because the start times of detecting each beam are the same, t₀ can also represent the common start time.

Because C₁, C₂, Vₐ₁, Vₐ₂, etc., are known numbers, based on the above formula (4), the target scaling factor k can be obtained as k=(C₂−C₁)/(Vₐ₂−Vₐ₁), and then the target scaling factor k is substituted into the first relationship corresponding to any one beam to calculate the common start time of detecting each beam to.

It can be understood that because the degree of aggregation is one of the peak width, full width at half maxima, standard deviation-related value, and quartile-related value in the histogram of the photon statistical results, under a condition that the types of degree of aggregation of the photon statistical results corresponding to each beam are the same, the scaling factors in the first relationships corresponding to each beam are the same (i.e., the target scaling factor), which can improve the convenience of determining the target scaling factor based on the first relationship and the second relationship, and thereby improve the convenience of determining the common start time of detecting each beam based on the target scaling factor.

Furthermore, the present disclosure can also determine the common start time of detecting each beam based on the photon statistical results corresponding to three or more return light beams, as shown in formula (5):

$${r}_{0} = {C}_{1} - {V}_{a 1} * k = {C}_{2} - {V}_{a 2} * k = {C}_{3} - {V}_{a 3} * k = … \qquad ( 5 )$$

where, C₃ represents the distribution center corresponding to a third return light beam, and Vₐ₃ represents the degree of aggregation corresponding to the third return light beam.

Due to possible minor jitter in the actual measurement process, which may result in no solution for the value of k in formula (5), the present disclosure can use statistical methods such as the method of least squares to obtain the statistical probability estimate value of k.

It can be understood that because the analysis is based on the photon statistical results of three or more return light beams, more data is analyzed, and the k value determined based on probability statistics has better compliance with the equations in formula (5), higher stability, and thus the accuracy of to calculated by formula (5) is higher, providing better ranging correction for target objects with different reflectivities.

In some embodiments, obtaining the photon statistical results of beams with different return light intensities reflected by the target object includes:

Obtaining the photon statistical results of beams with different return light intensities reflected by a plurality of target objects, where the distances to be measured of the plurality of target objects are the same.

It can be understood that by emitting beams to a plurality of target objects with the same distance to be measured, and obtaining the photon statistical results of beams with different return light intensities reflected by the plurality of target objects, the present disclosure can improve the timeliness of detecting beams with different return light intensities, thereby improving the timeliness of determining the distance to be measured.

In some embodiments, obtaining the photon statistical results of beams with different return light intensities reflected by the target object includes:

Under a condition that light beams of different intensities are emitted or/and photoelectric elements of different sensitivities are employed, obtaining the photon statistical results of the beams with different return light intensities reflected by the same target object.

In the present disclosure, when there is only one target object, by emitting beams with different intensities to the target object or/and using photoelectric elements with different sensitivities to detect the return light beams, the photon statistical results of beams with different return light intensities reflected by the same target object are obtained. Through this scheme, high-accuracy ranging can be achieved with only one target object.

In some embodiments, the method further includes:
Determining a ratio of the return light intensities of at least two beams reflected by the target object;
Determining a light reflectivity of the target object based on the ratio of the return light intensities and the distribution centers corresponding to each beam.

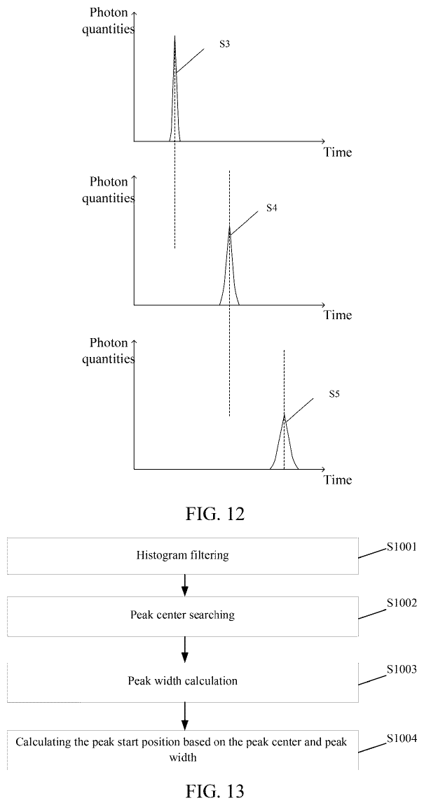

In the present disclosure, because the distribution centers corresponding to beams with different return light intensities reflected by the same target object are different, as shown in FIG. 12. FIG. 12 is an example diagram of statistical histograms corresponding to beams with different return light intensities, where S3 corresponds to a beam with high return light intensity, S4 corresponds to a beam with medium return light intensity, and S5 corresponds to a beam with low return light intensity (only the part of the photon statistical results near the distribution center is shown in the figure). The different return light intensities can be achieved by emitting laser sources with different intensities or by activating a different number of SPADs.

It can be seen that the degrees of shift of the distribution centers corresponding to beams with different return light intensities are different. Therefore, by comparing the degrees of shift of the distribution centers for beams of different return light intensities reflected by the same target object, the reflectivity of the target object can be determined. Specifically, the higher the reflectivity of the target object, the greater the shift of the distribution center of the beam reflected back in the histogram, but the degrees of shift of the distribution centers corresponding to multiple beams of different return light intensities are close, and the distribution centers are all shifted forward; the lower the reflectivity of the target object, the smaller the shift of the distribution center of the beam reflected back in the histogram, the degreed of shift of the distribution centers corresponding to multiple beams of different return light intensities are also close, and the distribution centers are all shifted backward (close to the distribution center in the ideal state). Therefore, based on the positions and degrees of shift of the distribution centers of beams of different return light intensities reflected by the target object in the histogram, the magnitude of the reflectivity of the target object can be judged.

In the present disclosure, multiple beams with various return light intensities can be set to have a multiple relationship, that is, the light intensities of various laser sources or the number of SPADs activated corresponding to each histogram have a multiple relationship, in order to obtain the ratio of the return light intensities of at least two beams reflected by the target object.

To this end, the present disclosure determines the ratio of the return light intensities of at least two beams reflected by the target object, and determines the light reflectivity of the target object based on the ratio of the return light intensities and the distribution centers corresponding to each beam. For example, taking the beam with low return light intensity as the base, the ratio of the return light intensities of three beams reflected by the target object from high to low is 81:9:1, and the ratio of the shift of the distribution centers of the three beams from high to low is a:b:1, thereby determining the light reflectivity of the target object based on the predetermined light reflectivity correspondence relationship; where the predetermined light reflectivity correspondence relationship includes the correspondence relationship between the ratio of the return light intensities, the ratio of the shift of the distribution centers, and the light reflectivity. Alternatively, based on the predetermined light reflectivity equation, the ratio of the return light intensities and the ratio of the shift of the distribution centers are calculated to obtain the light reflectivity. The aforementioned predetermined light reflectivity correspondence relationship and predetermined light reflectivity equation are obtained through multiple experiments.

It can be understood that the characteristic of different degrees of shift in the distribution centers corresponding to beams of different return light intensities in the present disclosure allows for a higher accuracy in determining the light reflectivity of the target object based on the ratio of the return light intensities of multiple return light beams and the distribution centers corresponding to each beam.

FIG. 13 is another flowchart of a reflection rate correction ToF ranging method provided by the present disclosure, which includes the following steps:
S1001, Histogram filtering;
In the present disclosure, the ranging device filters the statistical results of the photon flight time of the light pulses reflected by the target object, such as smoothing filtering, mean filtering, etc., to reduce the impact of light noise. Where, the statistical results include detection times of photons and photon quantities corresponding to the detection times.
S1002, Peak center searching;
In the present disclosure, the peak center corresponds to the aforementioned distribution center; the ranging device of the present disclosure determines the peak center of the photon quantities over the detection times based on the filtered statistical results. For example, the detection time corresponding to the highest peak in the histogram can be determined as the peak center of the photon quantities over the detection times; or the centroid algorithm can be utilized to process the filtered statistical results to determine the centroid of the histogram, and the detection time corresponding to the centroid can be determined as the peak center of the photon quantities over the detection times.
S1003, Peak width calculation;
In the present disclosure, the peak width corresponds to the aforementioned degree of aggregation; the ranging device of the present disclosure determines the peak width of the photon quantities over the detection times based on the filtered statistical results. For example, the weighted value of the peak width, full width at half maxima, standard deviation-related value, or quartile-related value in the histogram of the statistical results can be determined as the peak width of the photon quantities over the detection times.
S1004, Calculating the peak start position based on the peak center and peak width.
In the present disclosure, the ranging device determines the peak start position, which is the start time of detecting the light pulse as described above, by subtracting the peak width from the peak center.

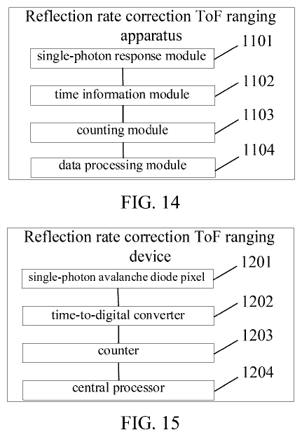

FIG. 14 shows an example diagram of a reflection rate correction ToF ranging apparatus provided by the present disclosure, which includes:
A single-photon response module 1101, configured to respond to detected photons; where the photons include photons of a light pulse reflected by a target object;
A time information module 1102, configured to obtain detection times of the photons of the light pulse;
A counting module 1103, configured to count and statistically analyze the detected photons to obtain statistical results; where the statistical results include the detection times of photons and photon quantities corresponding to the detection times;
A data processing module 1104, configured to determine a start time of detecting the light pulse based on the statistical results; and to determine a distance to the target object based on the start time of detecting the light pulse and a start time of emitting the light pulse.

In some embodiments, the data processing module 1104 is configured to determine a distribution center and a degree of aggregation of the photon quantities over the detection times based on the statistical results; and to determine the start time of detecting the light pulse based on the distribution center and the degree of aggregation of the photon quantities over the detection times.

In some embodiments, the degree of aggregation includes one of: a weighted value of a peak width, a full width at half maxima, a standard deviation-related value, or a quartile-related value in the histogram of the statistical results;
where, the standard deviation-related value refers to a length of a time interval corresponding to an integer multiple or a non-integer multiple of the standard deviation in the histogram of the statistical results;
the quartile-related value refers to a length of a time interval between any two quartiles in the histogram of the statistical results.

In some embodiments, the data processing module 1104 is configured to determine the start time of detecting the photons by subtracting the degree of aggregation from the distribution center of the photon quantities over the detection times.

In some embodiments, the standard deviation is a distribution standard deviation or a mapping standard deviation;
where, the distribution standard deviation refers to a standard deviation that reflects a distribution of the photon quantities over the detection times;
the mapping standard deviation refers to a standard deviation determined by the photon quantities based on a predetermined mapping relationship.

In some embodiments, the start time of emitting the light pulse includes:
one of a generation time of a control signal, a reception time of the control signal, or an actual emission time of the light pulse; where the control signal is a signal for controlling emission of the light pulse.

In some embodiments, the data processing module 1104 is configured to obtain a compensation coefficient related to the degree of aggregation and use the compensation coefficient to compensate for the degree of aggregation; subtract the compensated degree of aggregation from the distribution center of the photon quantities over the detection times to determine the start time of detecting the light pulse.

In some embodiments, the data processing module 1104 is configured to obtain a calibration error; determine a time difference between the start time of detecting the light pulse and the start time of emitting the light pulse; determine the distance to the target object based on the calibration error and the time difference.

FIG. 15 shows a reflection rate correction ToF ranging device provided by the present disclosure, which includes:
A single-photon avalanche diode pixel 1201, configured to respond to detected photons; where the single-photon avalanche diode pixel corresponds to the SPAD in the aforementioned single-photon avalanche diode array.
A time-to-digital converter 1202, configured to obtain detection times of the photons of the light pulse;
A counter 1203, configured to count and statistically analyze the detected photons to obtain statistical results; where the statistical results include the detection times of photons and photon quantities corresponding to the detection times;
A central processor 1204, configured to determine a start time of detecting the light pulse based on the statistical results; and to determine a distance to the target object based on the start time of detecting the light pulse and a start time of emitting the light pulse.

Where, the photons include photons of a light pulse reflected by a target object; if the SPAD detects a photon, it generates a pulse signal, and if the SPAD does not detect a photon, it does not generate a pulse signal.

The central processor 1204 in the present disclosure includes circuits such as a central processing unit (Central Processing Unit, CPU), a microcontroller unit (Microcontroller Unit, MCU), etc.

In some embodiments, the central processor 1204 is configured to determine a time at which a first photon is detected in the statistical results as the start time of detecting the light pulse;
or, determine a time at which a number of photons detected earliest is greater than a predetermined quantity threshold in the statistical results as the start time of detecting the light pulse.

In some embodiments, the statistical results include a statistical histogram of photon flight time, the histogram includes a plurality of time bins, each time bin represents a time interval, and a photon quantity corresponding to the time bin is a total number of photons detected at each detection time falling within the time interval of the time bin.

In some embodiments, the central processor 1204 is configured to determine a distribution center and a degree of aggregation of the photon quantities over the detection times based on the statistical results; and to determine the start time of detecting the light pulse based on the distribution center and the degree of aggregation of the photon quantities over the detection times.

In some embodiments, the distribution center of the photon quantities over the detection times is:
the detection time corresponding to a maximum photon quantity in the statistical results;
or, the detection time corresponding to a highest peak in the histogram;
or, a time point within the time bin corresponding to the maximum photon quantity in the histogram;
or, the detection time corresponding to a centroid of the histogram.

In some embodiments, the degree of aggregation of the photon quantities over the detection times includes:
a length of a time interval between a first detection time at which the photon quantity is greater than a quantity threshold and a last detection time at which the photon quantity is greater than the quantity threshold.

In some embodiments, the degree of aggregation includes one of: a weighted value of a peak width, a full width at half maxima, a standard deviation-related value, or a quartile-related value in the histogram of the statistical results;
where, the standard deviation-related value refers to a length of a time interval corresponding to an integer multiple or a non-integer multiple of the standard deviation in the histogram of the statistical results;
the quartile-related value refers to a length of a time interval between any two quartiles in the histogram of the statistical results.

In some embodiments, the central processor 1204 is configured to determine the start time of detecting the photons by subtracting the degree of aggregation from the distribution center of the photon quantities over the detection times.

In some embodiments, the standard deviation is a distribution standard deviation or a mapping standard deviation;
where, the distribution standard deviation refers to a standard deviation that reflects a distribution of the photon quantities over the detection times;
the mapping standard deviation refers to a standard deviation determined by the photon quantities based on a predetermined mapping relationship.

In some embodiments, the start time of emitting the light pulse includes:
one of a generation time of a control signal, a reception time of the control signal, or an actual emission time of the light pulse; where the control signal is a signal for controlling emission of the light pulse.

In some embodiments, the generation time of the control signal is a time at which a signal processing system generates the control signal.

In some embodiments, the reception time of the control signal is a time at which an optical emission system receives the control signal, or a time at which a timing element receives the control signal.

In some embodiments, the actual emission time of the light pulse is a time determined after compensating the generation time of the control signal based on a predetermined time compensation parameter; or a time determined after fitting a time at which the optical emission system receives the control signal based on a predetermined fitting function.

In some embodiments, the central processor 1204 is configured to obtain a compensation coefficient related to the degree of aggregation and use the compensation coefficient to compensate for the degree of aggregation; subtract the compensated degree of aggregation from the distribution center of the photon quantities over the detection times to determine the start time of detecting the light pulse.

In some embodiments, the compensation coefficient related to the degree of aggregation is obtained based on multiple experiments in an environment required for an application, or is determined based on a current measurement environment combined with parameters of the statistical results.

In some embodiments, the central processor 1204 is configured to obtain a calibration error; determine a time difference between the start time of detecting the light pulse and the start time of emitting the light pulse; determine the distance to the target object based on the calibration error and the time difference.

Correspondingly, the present disclosure provides a computer-readable storage medium, which stores a computer program, and the computer program, when executed by a processor, implements at least some or all steps of the method described above.

Correspondingly, the present disclosure provides a computer program product, which includes a non-transitory computer-readable storage medium storing a computer program, and the computer program, when read and executed by a computer, implements at least some or all steps of the method described above. The computer program product can be implemented through hardware, software, or a combination thereof. In one optional embodiment, the computer program product is embodied as a computer storage medium, and in another optional embodiment, the computer program product is embodied as a software product, such as a Software Development Kit (SDK), etc.

It should be noted that: the descriptions of the apparatus, storage medium, computer program product, and device embodiments mentioned above are similar to the descriptions of the method embodiments, and have similar beneficial effects as the method embodiments. For technical details not disclosed in the apparatus, storage medium, computer program product, and device embodiments of the present disclosure, please refer to the description of the method embodiments for understanding.

It should be understood that the term “one embodiment” or “an embodiment” mentioned throughout the specification means that specific features, structures, or characteristics related to the embodiment are included in at least one embodiment of the present disclosure. Therefore, the phrases “in one embodiment” or “in an embodiment” appearing throughout the specification do not necessarily refer to the same embodiment. In addition, these specific features, structures, or characteristics can be combined in any suitable manner in one or more embodiments. It should be understood that in the various embodiments of the present disclosure, the sequence numbers of the aforementioned processes do not necessarily mean the order of execution, and the order of execution of the processes should be determined by their functions and internal logic, and should not limit the implementation process of the embodiments of the present disclosure. The sequence numbers in the embodiments of the present disclosure are for description only and do not represent the superiority or inferiority of the embodiments.

It should be noted that in this text, the terms “include”, “comprise”, or any other variants are intended to cover non-exclusive inclusion, so that a process, method, item, or device that includes a series of elements not only includes those elements but also includes other elements that are not explicitly listed, or also includes elements inherent to that process, method, item, or device. Unless further limited, an element qualified by the phrase “including a . . . ” does not exclude the presence of additional same elements in the process, method, item, or device that includes that element.

In the several embodiments provided by the present disclosure, it should be understood that the devices and methods disclosed can be implemented in other ways. The device embodiments described above are exemplary, for example, the division of the units is a logical functional division, and there may be other division methods in actual implementation, such as: multiple units or components can be combined, or can be integrated into another system, or some features can be ignored, or not executed. In addition, the coupling or direct coupling, or communication connection between the various components shown or discussed can be through some interfaces, indirect coupling or communication connection between devices or units, and can be electrical, mechanical, or other forms.

The units described above as separate components can be, or can also not be physically separate, and the components shown as units can be, or can also not be physical units; they can be located in one place or distributed across multiple network units; some or all of the units can be selected based on actual needs to achieve the purpose of the embodiment of the present disclosure.

Furthermore, in the various embodiments of the present disclosure, the various functional units can all be integrated into one processing unit, or each unit can be a separate unit individually, or two or more units can be integrated into one unit; the integrated units can be implemented in the form of hardware or in the form of hardware plus software functional units.

Ordinary technicians in the field can understand that: all or part of the steps of the method embodiments mentioned above can be completed by related hardware through program instructions, and the aforementioned programs can be stored in computer-readable storage media, and when executed, the steps including the method embodiments mentioned above are executed.

Alternatively, if the integrated units mentioned above are implemented in the form of software functional modules and sold or used as independent products, they can also be stored in a computer-readable storage medium. Based on this understanding, the technical solution of the present disclosure can essentially or contribute to the related technology in the form of a software product, which is stored in a storage medium and includes several instructions for a computer device (which can be a personal computer, server, or network device, etc.) to execute all or part of the methods described in the various embodiments of the present disclosure.

Computer-readable storage media can be tangible devices that can maintain and store instructions used by instruction execution devices, and can be volatile storage media or non-volatile storage media. Computer-readable storage media can be any of the following but not limited to: electronic storage devices, magnetic storage devices, optical storage devices, electromagnetic storage devices, semiconductor storage devices, or any suitable combination of the above. Examples of computer-readable storage media (a non-exhaustive list) include: portable computer disks, hard disks, random access memory (Random Access Memory, RAM), read-only memory (Read Only Memory, ROM), erasable programmable read-only memory, memory sticks, floppy disks, mechanical encoding devices, such as punch cards or grooved structures with protruding structures stored thereon, and any suitable combination of the above. The computer-readable storage media used herein is not interpreted as transient signals themselves, such as radio waves or other free-propagating electromagnetic waves, electromagnetic waves propagated through waveguides or other transmission media (such as optical pulses through optical fiber cables), or electrical signals transmitted through wires.

The above description is only one embodiment of the present disclosure, but the protection scope of the present disclosure is not limited to this. Any technician familiar with the technical field can easily think of variations or replacements within the technical scope disclosed by the present disclosure, and they should all be covered within the protection scope of the present disclosure. Therefore, the protection scope of the present disclosure should be determined by the protection scope of the claims.

What is claimed is:

1. A reflection rate correction Time of Flight (ToF) ranging method, the method comprising:
obtaining statistical results of photon flight time of a light pulse reflected by a target object;
wherein the statistical results comprise detection times of photons and photon quantities corresponding to the detection times determining a start time of detecting the light pulse based on the statistical results;
determining a distance to the target object based on the start time of detecting the light pulse and a start time of emitting the light pulse.

2. The method of claim 1, wherein the determining the start time of detecting the light pulse based on the statistical results comprises: determining a time at which a first photon is detected in the statistical results as the start time of detecting the light pulse; or, determining a time at which a number of photons detected earliest is greater than a predetermined quantity threshold in the statistical results as the start time of detecting the light pulse.

3. The method of claim 1, wherein the statistical results comprise a statistical histogram of photon flight time, the histogram comprising a plurality of time bins, each time bin representing a time interval, and a photon quantity corresponding to the time bin is the total number of photons detected at each detection time falling within the time interval of the time bin.

4. The method of claim 1, wherein the determining the start time of detecting the light pulse based on the statistical results comprises: determining a distribution center and a degree of aggregation of the photon quantities over the detection times based on the statistical results; and determining the start time of detecting the light pulse based on the distribution center and the degree of aggregation of the photon quantities over the detection times.

5. The method of claim 4, wherein the degree of aggregation of the photon quantities over the detection times comprises: a length of a time interval between a first detection time at which the photon quantity is greater than a quantity threshold and a last detection time at which the photon quantity is greater than the quantity threshold.

6. The method of claim 4, wherein the degree of aggregation comprises one of: a weighted value of a peak width, a full width at half maxima, a standard deviation-related value, or a quartile-related value in the histogram of the statistical results;
wherein the standard deviation-related value refers to a length of a time interval corresponding to an integer multiple or a non-integer multiple of the standard deviation in the histogram of the statistical results;
the quartile-related value refers to a length of a time interval between any two quartiles in the histogram of the statistical results.

7. The method of claim 4, wherein the determining the start time of detecting the light pulse based on the distribution center and the degree of aggregation of the photon quantities over the detection times comprises:
determine the start time of detecting the photons by subtracting the degree of aggregation from the distribution center of the photon quantities over the detection times.

8. The method of claim 6, wherein the standard deviation is a distribution standard deviation or a mapping standard deviation;
wherein the distribution standard deviation refers to a standard deviation that reflects a distribution of the photon quantities over the detection times;
the mapping standard deviation refers to a standard deviation determined by the photon quantities based on a predetermined mapping relationship.

9. The method of claim 1, wherein the start time of emitting the light pulse comprises: one of a generation time of a control signal, a reception time of the control signal, or an actual emission time of the light pulse; wherein the control signal is a signal for controlling emission of the light pulse.

10. The method of claim 9, wherein the actual emission time of the light pulse is a time determined after compensating the generation time of the control signal based on a predetermined time compensation parameter; or a time determined after fitting a time at which an optical emission system receives the control signal based on a predetermined fitting function.

11. The method of claim 4, wherein the determining the start time of detecting the light pulse based on the distribution center and the degree of aggregation of the photon quantities over the detection times comprises:
obtaining a compensation coefficient related to the degree of aggregation and using the compensation coefficient to compensate for the degree of aggregation;
subtracting the compensated degree of aggregation from the distribution center of the photon quantities over the detection times to determine the start time of detecting the light pulse.

12. The method of claim 1, wherein the determining the distance to the target object based on the start time of detecting the light pulse and the start time of emitting the light pulse comprises:
obtaining a calibration error;
determining a time difference between the start time of detecting the light pulse and the start time of emitting the light pulse;
determining the distance to the target object based on the calibration error and the time difference.

13. The method of claim 1, wherein the obtaining the statistical results of photon flight time of the light pulse reflected by the target object comprises: obtaining photon statistical results of beams with different return light intensities reflected by the target object; the determining the start time of detecting the light pulse based on the statistical results comprises: determining a common start time of detecting each beam based on the photon statistical results corresponding to each beam; the determining the distance to the target object based on the start time of detecting the light pulse and the start time of emitting the light pulse comprises: determining the distance to the target object based on the common start time of detecting each beam and the start time of emitting the beam.

14. The method of claim 13, wherein the determining the common start time of detecting each beam based on the photon statistical results corresponding to each beam comprises:
determining, for the photon statistical results corresponding to each beam, a distribution center and a degree of aggregation of the photon quantities over the detection times corresponding to the beam;
obtaining a first relationship between the start time of detecting the beam and the distribution center, the degree of aggregation, and a scaling factor corresponding to the beam, as well as a second relationship between the start times of detecting each beam;
determining the common start time of detecting each beam based on the first relationship and the second relationship.

15. The method of claim 14, wherein the determining the common start time of detecting each beam based on the first relationship and the second relationship comprises:
under a condition that types of degree of aggregation of the photon statistical results corresponding to each beam are the same, determining a target scaling factor based on the first relationship and the second relationship;
determining the common start time of detecting each beam based on the target scaling factor and the first relationship.

16. The method of claim 13, wherein the obtaining the photon statistical results of beams with different return light intensities reflected by the target object comprises:
obtaining the photon statistical results of beams with different return light intensities reflected by a plurality of target objects, wherein the distances to be measured of the plurality of target objects are the same.

17. The method of claim 13, wherein the determining the distance to the target object based on the common start time of detecting each beam and the start time of emitting the beam comprises:
determining a time difference between the common start time of detecting each beam and a start time of emitting any one beam;
using the time difference as the photon flight time, and determining the distance to the target object based on the photon flight time.

18. The method of claim 13, further comprising:
determining a ratio of the return light intensities of at least two beams reflected by the target object;
determining a light reflectivity of the target object based on the ratio of the return light intensities and the distribution centers corresponding to each beam.

19. A reflection rate correction Time of Flight (ToF) ranging device, the device comprising:
a single-photon avalanche diode pixel configured to respond to detected photons; wherein the photons comprise photons of a light pulse reflected by a target object;
a time-to-digital converter configured to obtain detection times of the photons of the light pulse;
a counter configured to count and statistically analyze the detected photons to obtain statistical results; wherein the statistical results comprise the detection times of photons and the photon quantities corresponding to the detection times;
a central processor configured to determine a start time of detecting the light pulse based on the statistical results; and to determine a distance to the target object based on the start time of detecting the light pulse and a start time of emitting the light pulse.

20. A computer-readable storage medium storing a computer program, the computer program, when executed by a processor, implementing the following operations:
obtaining statistical results of photon flight time of a light pulse reflected by a target object; wherein the statistical results comprise detection times of photons and photon quantities corresponding to the detection times
determining a start time of detecting the light pulse based on the statistical results;
determining a distance to the target object based on the start time of detecting the light pulse and a start time of emitting the light pulse.
